(19) United States
(12) Patent Application Publication
(10) Pub. No.: US 2014/0277800 A1
(43) Pub. Date: Sep. 18, 2014

(54) Power Management System For A Structure

(71) Applicant: Tom E. Hughes, Oklahoma City, OK (US)

(72) Inventor: Tom E. Hughes, Oklahoma City, OK (US)

(21) Appl. No.: 13/834,054

(22) Filed: Mar. 15, 2013

(51) Int. Cl. G05F 1/66

(52) U.S. Cl. CPC G05F 1/66
USPC 700/292; 700/291; 700/287

(57) ABSTRACT

A power management system installed in a structure and placed electrically between at least one circuit breaker and at least one circuit supplying at least one electrical load, the system comprising a digital controller having a power source; at least one switch communicating with a digital controller and positioned between an electrical load and a breaker to selectively energize at least one circuit; a display communicating with the digital controller; and a user interface communicating with the digital controller, whereby the digital controller selectively engages and disengages the power to selected circuits by communication with at least one switching device using user inputs entered through the interface enabling a user to manage power consumption within the structure.

### CROSS-REFERENCE TO RELATED APPLICATIONS

None.

### FIELD OF THE INVENTION

The invention relates to systems and methods for use to monitor and control electrical usage in a structure.

### SUMMARY OF THE INVENTION

In recent years a growing amount of attention has been given to demand side management and energy consumption. The problem many utility companies face is that for much of the year the power demand can be met by base-load generation plants such as coal and combined cycle plants. However during the particularly hot or cold times of the year home thermostats kick on and boost the energy consumption of home and business owners creating what is commonly referred to as a peaking demand for energy. The peak load is difficult to manage and predict and is typically met with low capital cost but high operating cost technologies such as simple cycle gas turbines. In recent years this problem has been further compounded by the addition of non-dispatchable renewable technologies such as wind turbines which only generate when the wind is blowing and cannot be called on to meet peaking demands.

Throughout the country many utilities have sufficient generation capacity to meet the overall energy demand, but are rapidly approaching peak power limitations and may be forced to build small inefficient power plants. As an alternative to building new plants, many utilities have begun to investigate “time of use” rates, such as Oklahoma Gas & Electric's “Smart Hours®” program, where consumers see a higher electricity price at certain times of the day to discourage electricity use at that time and lower rates at off-peak times. To facilitate this time variable pricing, many utility companies have encourage the use of programmable “smart” thermostats which allow the heating and air conditioning set point to drift during peak times. These reduce the use of heaters and air conditioners during peak hours, but completely ignores all of the other home energy loads such as water heaters, appliances, electronics, and other miscellaneous technologies. Although heating and air conditioning represent the largest portion of the load in a home, ignoring the other loads misses around half of the home energy loads which could be managed.

There is a lack of existing technology to address these and other issues. There are no commercial off-the-shelf technologies which allow the do-it-yourself home owner to effectively manage both the residential home consumption across various devices in an easy cost effective manner. Although home automation technologies have been available in various forms for several decades, these technologies are typically expensive and difficult to install. These technologies have been commercialized by technical gurus for technical gurus, leaving the common home owner with few alternatives.

Recent innovations in digital communication such as tablet computing and smart phones have created a portal in which the average home owner can interact with complex devices in an easy to use manner. Furthermore, using these technologies allows the control system to be decoupled from the interface device so that the home control technology can be sold separate from the control device making the systems more affordable. Despite these obvious advances, most home automation companies continue to pursue expensive high tech control systems and complicated interfaces.

In addition to the complex automation technologies, a number of companies have recently begun to provide home energy monitoring tools and services. These technologies give users useful data about how energy is used in the home, but do little to actively manage the consumption of home energy. Users are provided intermittent feedback which encourages them to reprogram thermostats, add insulation, glaze windows, examine lighting loads, and examine energy use. Although the technologies do a good job encouraging smart energy-saving behavior they fail to give users the tools needed to actively respond to loads and manage energy in an easy and simple manner.

The present invention takes advantage of existing technology and layers on a solution to meet the needs of the mainstream consumer market rather than focusing on the small niche of technocrats who the home automation companies currently cater to. To accomplish this objective, the inventor looked at a typical home to see what the natural control point was, and determined that because all electricity coming into the home runs through the circuit breaker, also known as a “load center,” that architecture makes it the most natural hub for electrical control in a home or other structure. By placing a device at or near the breaker panel, the owner can control every switchable circuit in a structure without having to go through a number of complex installations at every power outlet, light socket, and appliance in the structure. Furthermore, by clustering the control device into a single component a more cost effective solution is presented as communication can generally be routed through a single port rather than a through complex network of signal technologies.

In addition the control of selected circuits, the smart panel may also monitor energy consumption and provide consumers with active feedback via email, short message service (“SMS” or text messages), by native application message, or by other well-known message delivery means to let them know when energy prices increase and provide options to manage power. For example, if a home owner's water heater or oven is turned on during a peak pricing hours, the smart panel could detect the increase in power and send the users an SMS message or email letting them know that the power surge will cost $3.38 to run for the next hour, but waiting until outside of peak pricing will reduce the price to $0.30 (prices are for example only). A user could then easily turn off the active circuit over the phone, or leave it on if they really need to use the appliance at that time. In this way the smart panel provides not only the information about energy consumption, but also the tools to actively manage consumption.

The invention is designed to be as easy to install as a ceiling fan, and take minimal effort to program. The invention provides a framework and platform such that home circuits can be controlled via personal computer, laptop computer, tablets or smart phone technologies. The invention may also feature an integral touch screen for easy setup and programming.

Value for customer is provided in part because the invention can cut parasitic loads allowing the home owner to save a significant amount of money each month on their home electricity bill. Following operating guidelines, it is estimated a typical home owner can cut their annual energy bill by roughly 20% simply by shifting their load and shutting off unused circuits. For the typical homeowner the present invention may pay for itself in less than two years in electricity bill reductions.

In addition to the saved energy, the present invention may also provide an additional set of benefits which are difficult to quantify, but very important to recognize as these factors are likely to motivate product purchase. A few of these factors include: home control, security programming, energy consumption information, and improved ease of distributed generation integration.

The invention has, among others, the following three major design aspects: (a) the electronics design provides the control circuitry which allows circuits to be turned on and off by a digital controller; (b) an optional physical case for a smart panel providing an easy-to-install user-friendly interface which allows the average owner to self-install a smart panel; and (c) the digital architecture may interface with a digital control network which may allow the invention to be controlled from any kind of digital interface devices such as smart phones, tablets, personal computers (PCs), or built in liquid crystal display (LCD) controllers.

The digital controller preferably includes a printed circuit board connected to digital relays which allow the smart panel to energize or de-energize individually controlled circuits. These relays are controlled via a microcontroller which provides the interface between a display panel and other optional wireless devices. The microcontroller is also preferably provided with software which allows it to shut off circuits based on pre-specified inputs such as time of day or power price.

The digital controller may contains one main chip such as that used in an Arduino Mega® microcontrollers which features an ATmega1280® chip. This chip has 54 digital input/output pins and 16 analog input/output pins, which is more than is likely to be needed for this application; thus, although the current design features an ATmega1280 chip, the final configuration may use a simpler and less expensive chip. Connected to the main chip may be branch board connections as well as at least one current sensor. These current devices send a signal into the two analog inputs on the main chip. The analog input is then read and processed by the main chip where it is sent to the LCD screen and the wireless network for reporting to owners using this invention.

From the main controller board at least one additional board may be used to house the wiring and digital relays for each circuit. The relay control circuitry may feature a series of 1 k ohm and 10 k ohm resistors, a diode, and a transistor. The main controller may send a signal to a transistor which opens or closes the 5V lead to the relay device. The digital leads may be wired from the main circuit panel into each of the branch panels. The relay device may be wired in parallel with a diode. The digital signals coming from the main board via the transistor allow each of the relay control circuits to be turned on and off. The alternating current (AC) power leads coming off of each of the breakers that traditionally run into the house are typically disconnected and replaced with wires coming off the back of the smart panel. As such, the smart panel relays may be wired in series with the traditional breakers, allowing traditional breakers to continue performing the traditional current overload protection as designed, while the smart panel acts to provide energy management control only. The AC wiring coming into and out of the smart panel is designed such that they can be disconnected from the smart panel (if needed) to facilitate quick and easy installation. The current preferred apparatus is a quick push connector, although other connection options may be implemented later.

The electronics components would preferably be physical arranged such that the only wiring required would be to connect each of the leads from the structure to the outgoing side of the smart panel and then connect the incoming side of the smart panel to each of the breakers for switchable circuits. Preferably, all other electronic circuitry would be hardwired and internal to the smart panel case.

All of the printed circuits associated with the invention will preferably be encapsulated inside of the physical smart panel case. Installation will start with the homeowner turning off the main breaker and removing the cover plate from the existing circuit breaker panel. The user would then use clamp-on optional current sensors around each of the main power leads into the structure to collect real time or near real time power consumption data. These sensors are easy to install and simply snap around the power lines, measuring the power draw by reading the induced current around the lead. After installing the optional current sensors, the user attaches the smart panel cover to make the connections from the existing breaker box to the smart panel.

The basic existing configuration behind the cover of a breaker box contains a bundle of wires which run hot from a bus bar to the house and back to the neutral bar. There are also ground wires in most circuits to provide some degree of electrical protection. The smart panel wiring can utilize this typical existing arrangement for neutral and ground, so the user only needs to make connections from the breaker to the smart panel and then back to the load.

To wire the smart panel, a user may first disconnect the main house load from the breaker via the screw in place on the breaker. This load side lead is then taken to the corresponding location on the breaker panel. Users then connect a new wire from the breaker which was just disconnected to the corresponding point on the other side of the smart panel to complete the circuit.

Although an integrated smart panel configuration is expected to be the most cost effective and economic method to achieve breaker box control, it is recognized that some users may prefer an individual breaker and control device rather than the full case design option. For those users who wish to use only a couple of breakers, an alternate configuration of the technical components is achieved in the form of a breaker with an encapsulated relay. In this configuration, the branch board circuitry is broken up into individual boards for each breaker and encapsulated in the case of an individual breaker itself. The breaker case would be similar to a traditional ground fault interruption (GFI) breaker, however the GFI circuitry would be replaced with a relay circuit to achieve control of the device without affecting the normal operation of the breaker. The load control for this device may have a control wire, a positive lead, and a ground, which would be run from each board back to a digital controller. The three wires would preferably be twisted and paired so that the user has a single plug connection for each breaker to connect to the digital controller. Alternatively, the communication between a breaker and the digital controller may be accomplished wirelessly using known wireless technologies discussed herein.

The objective of the present invention is to allow users to easily manage and control energy consumption in their homes. To facilitate that, an intuitive software application that communicates seamlessly with the panel on multiple devices and platforms is required. The currently preferred display screen would be a graphic representation of the breaker panel, with user defined labels on each circuit. Each circuit would feature a color coded button that would display the setting that the breaker is in, and allow the user to switch between settings. In this configuration a red indicator would indicate the circuit is off, green that the circuit is on, and yellow that the circuit is in standby to alarm the user if the consumption exceeds a certain threshold. Although it may be cost prohibitive to directly monitor each circuit, the load signatures of each circuit would be recorded and tracked accordingly. The invention does include directly monitoring each circuit. Also on the switch panel display would preferably be the power draw, estimated energy price, and monthly bill tracking to provide an estimate on the current electricity bill.

The first method of control would be pre-programmed sensor/time based automated commands to have certain circuits turn off automatically based on the pre-programmed logic. In this scenario the invention would have an internal clock to shut off circuits at specified times, or would receive data from various local sensors (external to the panel) which would tell certain circuits to be shut down. Additionally, users should be able to easily override these programs by sending commands from a remote device. For local commands a local wireless interface may also be implemented so that users can remotely communicate with the invention. For long distance, remote control, the invention would be able to communicate over the internet via a WiFi® connection to the structure's main router. The current preferred method to accomplish this would be to give the digital controller an internet protocol (IP) address so that information and commands can be sent to the digital controller and executed in real time. Users would send a signal to the targeted IP address over the internet, which would be read and executed by the system.

In order for everything to seamlessly synchronize with multiple devices, it is necessary for the invention to also capture feedback of changes on a remote network, which would update the current status of each circuit. To accomplish this, a remote server may also be incorporated into the communications loop so that when a remote device logs in to the system, it is automatically updated with the current status and setting of each circuit. In this way, users should be able to seamlessly control the system from a computer, tablet, or cell phone device.

The system's communication is facilitated by a series of data transfers and signals. The remote device first connects to the internet and logs into a remote server which updates the panel and/or the remote on the current status of all switches. The device can then be used to change the setting of any switch. This information is passed to digital controller, preferably via the local IP address. From there the digital controller may send a 5V (typical) signal to the digital relay. This allows the relay to open or close the switch which allows the household devices to be turned on or off accordingly.

The long term goal of the system is to provide electricity consumers with the tools to achieve electricity independence. Although the focus of the system is on developing a structure-based energy management tool via remote relays in the circuit breaker, the technology does create a unique control interface with the structure. This interface provides the capability for owners not only to manage their own electricity draw from the grid, but also to manage their own power generation. In this scenario, the energy draw of the home could be easily synchronized with the various generation technologies to provide truly independent power systems that are both affordable and easy to install.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a view of the power management system incorporated into a building structure, according to a preferred embodiment of the present invention.

FIG. 2 is a detailed view of the power management system, according to a preferred embodiment of the present invention.

FIG. 3 is a side view of the modified ground fault interrupter (GFI) circuit breaker where the switch has replaced the GFI circuitry and placed electrically in the power management system, according to a preferred embodiment of the present invention.

FIG. 4 shows a smart panel with an integrated display with the access doors closed.

FIG. 5 shows a smart panel with an integrated display with the access doors open.

FIG. 6 is an iconic representation of the status indicator lights on a smart panel displayed on several different types of remote devices.

FIG. 7 is an iconic representation of a smart panel, a server, and a remote device all in wireless communication.

### DETAILED DESCRIPTION OF THE INVENTION

FIG. 1 illustrates a power management system consistent with the present invention. A power source 100 exists to provide power to the structure 112. The input power 102 first passes through a load center 104 which has at least one circuit breaker 106 contained therein. The load center 104 may also commonly be referred to a “breaker box” or similar terms. From there, power to switchable loads 110 is fed out to a smart panel 108. The smart panel 108 is a digital control component designed to provide analysis and control consistent with the teachings of this disclosure. The smart panel 108 is related to “smart grid” systems and may be integrated therewith, but it is not the same thing as a “smart meter.” After passing through the smart panel 108, switchable electrical loads 110 are fed through the structure's wiring. Non-switchable loads 114 are fed directly from the load center 104.

FIG. 2 illustrates, in greater detail, an embodiment of a system consistent with the present invention. Input power 102 feeds the system. It may pass through a current sensor 224 to determine the total power being fed into the structure 112. After passing through an optional current sensor 112, the input power 102 passes into the load center/breaker box 104. Contained within the load center 104 is at least one circuit breaker 106, and more typically, there are a plurality of circuit breakers.

Non switchable loads 114, which are those loads requiring constant supply of power, are fed directly from the load center 104. The power to non-switchable loads does not pass through the smart panel 108 because they are not susceptible to being interrupted to minimize power consumption. Power to feed switchable loads 110 passes into the smart panel 108. A switch 214 preferably exists for each separate circuit supplying a switchable load 110. The switch 214 in an on position, supplies a switchable electrical load 110. In an off position, as controlled by the digital controller 200, the switch 214 prevents power from being supplied to the switchable load 110.

The digital controller 200 typically includes Memory 202 and a digital processor 216 both of which are supplied with power 212. Also typically included in the digital controller 200 is an input output (I/O) interface 210. The I/O interface 210 facilitates communication with external digital equipment or sensors such as the current Sensor 224. The I/O interface may also communicate with a communications module 208, and it provides for communication with a display 206 and a user interface 204. The display 206 and user interface 204 are used to communicate with the user, and may be local versions of these elements physically fixed adjacent to the smart panel 108.

Also shown in FIG. 2 in communication with the system via a communication link 226 is a remote 218. The link 226 is a wireless connection between a communications module 208 in the smart panel 108 and a cooperating communication component 228 in the remote 218. The remote 218 will preferably have both a remote display 222 and a remote user interface 220. The remote 218 may be any number of different types of devices including but not limited to cellular telephones, laptop computers, tablet computers, desktop computers, or remote keypads for communication with, monitoring and control of the system.

FIG. 3 shows a removable breaker 300 for use with an embodiment of the invention. The removable breaker 300 is housed in a one of a number of commercially-available standard breaker case designs. These commercially-available breaker case designs are adapted to be easily snapped into place in a breaker panel/load center. The removable breaker 300 contains a standard circuit breaker 106, which serves the function of turning off power to a load if the current exceeds the rated capacity of the circuit breaker 106. A manual switch 302 is provided to manually turn off power to a load. The removable breaker 300 typically receives power through a pair of input breaker terminals 304 and, assuming the breaker has not been tripped or turned off, power passes out of the removable breaker 300 to an electrical load through a pair of output breaker terminals 306. The improvement here is that the Switch 214 is integrated into the Breaker 300. An entire traditional breaker can be replaced with one according to the present invention, where the breaker consistent with the present invention has a connection to the digital controller 200. The connection between the switch 214 contained within the removable breaker 300 and the digital controller 200 may be through a separate low voltage wire 308. Alternatively, the switch 214 may communicate wirelessly with the digital controller 200 via any number of wireless communication protocols that are available or others that as specifically developed for use with the present invention.

FIGS. 4 and 5 show a smart panel 108 incorporating an integrated smart panel display 400. A pair of smart panel doors 402 are retained in a closed position by a pair of smart panel door latches 404. The remainder of a front surface of the smart panel is comprised of a smart panel cover 406. With the doors 402 in an open position as in FIG. 5, breakers 106 and open breaker receiver slots 502 can be seen. As with traditional breaker boxes, the smart panel 108 preferably has a plurality of receiver slots 502 are provided into which appropriate breakers 106 can be inserted and which may leave a few open slots to accommodate future expansion of a system.

FIGS. 6 and 7 iconically illustrate the system. FIG. 6 shows an illustrative embodiment of what may be displayed on the display 206, whether it is an integrated smart panel display 400 or a remote display presented on a smart phone 618, a laptop 620, or a tablet 622 wherein these remote displays use the cloud 624, a computing technology, as a vehicle to communicate with the smart panel 108 to derive their display information. Preferably, the icons displayed include those shown in FIG. 6 such as an red dot 602 indicating that the referenced circuit is switched to a de-energized state, a green dot 604 indicating that the referenced circuit is energized, or a yellow dot 606 indicating that the referenced circuit is in an automatically-monitored state. Circuits indicated by a yellow dot 606 may be programmed to turn off at specific times during the day or to turn off when other conditions are satisfied or to alert a user at certain times or under certain conditions. For example, a user could program the system to push a notification to his smart phone 618 when a specified circuit is energized during peak energy cost periods. Also shown in FIG. 6 are several preferable informational matters such as the current power draw of the structure 608, the energy price per unit applicable to consumption in the structure 610, the estimated monthly bill based on the real-time usage 612 and one or more icons 614 leading to menus adapted to modify the parameters of the system. Additionally, with multiple devices enabling the user to make changes, these changes should be reflected on each device, i.e. synchronized, after the change or changes have been made in order to provide seamless operations. To perform the synchronization function, a server 700 would capture these changes of the remote device and automatically updates any device that becomes active within the cloud 624 with the current status and settings of each circuit.

The purpose of the abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

While the invention has been shown, illustrated, described and disclosed in terms of specific embodiments or modifications, the scope of the invention should not be deemed to be limited by the precise embodiments or modifications therein shown, illustrated, described or disclosed. Such other embodiments or modifications are intended to be reserved especially as they fall within the scope of the claims herein appended.

Having thus described the invention, I claim:

1. A power management system installed in a structure and placed electrically between at least one circuit breaker and at least one circuit supplying at least one electrical load, the system adapted to selectively energize at least one switchable circuit, the system comprising:
a. a digital controller having a power source;
b. at least one switch positioned between an electrical load and a breaker, the switch adapted to receive an input from the digital controller to selectively energize at least one circuit;
c. a display communicating with the digital controller and adapted to receive system information from the digital controller and display it to a user; and
d. a user interface communicating with the digital controller, the user interface adapted to receive user inputs, the user interface selected from switches, buttons, keypads, and touch screens,
whereby the power management system is electrically positioned between at least one breaker and an electrical load, the digital controller selectively engaging and disengaging the power to selected circuits by communication with at least one switching device using user inputs entered through the interface enabling a user to manage power consumption within the structure.

2. The system of claim 1, where the digital controller is selected from a microprocessor, a microcontroller, and a programmable logic controller.

3. The system of claim 1, including at least one sensor selected from light, motion, temperature, magnetic fields, humidity, moisture, vibration, pressure, electrical fields, and sound, each sensor in communication with the digital controller.

4. The system of claim 1 where a sensor monitoring total power used in the structure is monitored and displayed.

5. The system of claim 1 in which the switch is physically integrated into a breaker adapted to be received in a breaker panel.

6. The system of claim 1 further comprising:
a. a network in communication with the digital controller,
b. at least one remote device into which a display and user interface are integrated and which communicates with the digital controller through the network.

7. The system of claim 6 further including at least a second display and second user interface affixed to the structure and also in communication with the digital controller.

8. The system of claim 6 where the network wirelessly communicates with the remote device.

9. The system of claim 8, where the wireless communication includes at least one mode selected from WIFI®, cellular telephone network, Bluetooth®, ZigBee®, XBee®, and infrared.

10. The system of claim 8 where the system further is in communication with a smart meter system deployed in conjunction with a provider of power to the structure.

11. The system of claim 10 wherein the power management system receives price information regarding time variable electricity pricing and analyzes the information and communicates relevant information to at least one remote, whereby a user may choose to disconnect circuits and may be notified of the estimated system costs.

12. The system of claim 6, where the remote is selected from a cellular phone, a laptop, a tablet computer, and home automation control device.

13. The system of claim 8, where a server is in communication with the system, the server adapted to capture setting and status changes and automatically update changes upon a remote device connecting to the network.

14. The system of claim 6 further comprising a power generation source operated by the owner of the structure where the digital controller is programmed to control uses in conjunction with availability of power from the generation source.

15. The system of claim 14, the generation source comprising solar power and a sensor being in communication with the digital controller relaying power available from solar panels.

16. The system of claim 14, the generation source comprising wind power and a sensor being in communication with the digital controller relaying power available from a wind generator.

17. The system of claim 6 wherein the digital controller is programmed with event or timed triggers adapted to selectively energize at least one circuit.

18. The system of claim 6 further comprising a source of stored power operated by the owner of the structure where the digital controller is programmed to control uses in conjunction with availability of power from the storage source.

19. The system of claim 18, the storage source comprising batteries and a sensor being in communication with the digital controller relaying power available from batteries.

20. A method for installing a power management system in a structure comprising the steps of:
a. identifying circuits that are switchable;
b. selecting the desired switchable circuits to be controlled by the system;
c. installing any needed circuits breakers not already in place;
d. installing control components including—
i. a digital controller having a power source,
ii. at least one switch positioned between an electrical load and a breaker, the switch adapted to receive an input from the digital controller to selectively energize at least one circuit,
iii. a display communicating with the digital controller adapted to receive system information from the controller and display it to a user, and
iv. a user interface communicating with the digital controller, the interface adapted to receive user inputs to the system, where the user interface is selected from switches, buttons, keypads, and touch screens;
e. connecting any new breakers to circuits not selected to be switched by the system;
f. connecting at least one selected switchable circuit to a switch for each circuit;
g. configuring the system to control each switch,
whereby the power management system is specifically designed to accommodate and mated to selected circuits where the system is electrically positioned between the breakers and the circuits wherein the digital controller can selectively engage and disengage the power to selected circuits by communication with at least one switching device using user inputs entered through the interface enabling a user to manage power consumption within the structure.

21. The method of claim 20 wherein the digital controller is programmed with user defined messages and displayed to the user.

22. The method of claim 20 wherein the digital controller is programmed with event or timed triggers adapted to selectively energize at least one circuit.

23. The method of claim of claim 20 wherein a remote device including at least a second display and second user interface spatially separated is configured to communicate with the digital controller.

24. The method of claim 20 wherein the digital controller is configured to wirelessly communicate with a remote device.

25. The system of claim 24, where the wireless communication includes at least one mode selected from WIFI®, cellular telephone network, Bluetooth®, ZigBee®, XBee®, and infrared.

26. A power management system installed in a structure and placed electrically between at least one circuit breaker and at least one circuit supplying at least one electrical load, the system adapted to selectively energize at least one switchable circuit, the system comprising:
a. a digital controller having a power source;
b. at least one switch positioned between an electrical load and a breaker, the switch adapted to receive an input from the digital controller to selectively energize at least one circuit;
c. a display communicating with the digital controller and adapted to receive system information from the digital controller and display it to a user; and
d. a user interface communicating with the digital controller, the user interface adapted to receive user inputs, the user interface selected from switches, buttons, keypads, and touch screens;
e. at least one sensor selected from light, motion, temperature, magnetic fields, humidity, moisture, vibration, pressure, electrical fields, and sound, each sensor in communication with the digital controller;
f. a network in communication with the digital controller;
g. at least one remote device into which a display and user interface are integrated and which communicates with the digital controller through the network; and
h. a server in communication with the system, the server adapted to capture setting and status changes and automatically update changes upon a remote device connecting to the network,
whereby the power management system is electrically positioned between at least one breaker and an electrical load, the digital controller selectively engaging and disengaging the power to selected circuits by communication with at least one switching device using user inputs entered through the interface enabling a user to manage power consumption within the structure.
